(19) United States
(12) Patent Application Publication
(10) Pub. No.: US 2012/0166681 A1
(43) Pub. Date: Jun. 28, 2012

(54) INFORMATION PROCESSING DEVICE, INFORMATION PROCESSING SYSTEM, INFORMATION PROCESSING METHOD, AND PROGRAM

(75) Inventor: Kai Suzuki, Tokyo (JP)

(73) Assignee: SONY CORPORATION, Tokyo (JP)

(21) Appl. No.: 13/327,215

(22) Filed: Dec. 15, 2011

(30) Foreign Application Priority Data
Dec. 22, 2010 (JP) 2010-286123

(51) Int. Cl. G06F 3/00

(52) U.S. Cl. 710/18

(57) ABSTRACT

An information processing device includes a serial transfer interface which performs serial transfer for data in a unit of packets between counterparty devices, a transfer control unit which performs control of data transfer of the serial transfer interface, and a transfer state monitoring unit which monitors a data transfer state including a data size being subjected to data transfer of the serial transfer interface, determines and can change the maximum data size of a transmission packet to be transmitted next according to the monitored state, and supplies the determined maximum data size to the transfer control unit, and the transfer control unit performs control of data transfer of the serial transfer interface according to the maximum data size of the transmission packet supplied from the transfer state monitoring unit.

### BACKGROUND

The present disclosure relates to an information processing device, an information processing system, an information processing method, and a program which are provided with a serial transfer interface (I/F) such as a PCI (Peripheral Component Interconnect) Express interface, or the like.

As a data transfer interface (I/F) between host equipment such as a personal computer and a portable information processing device mounted with a non-volatile memory, a PCI Express I/F employing not a parallel transfer scheme but a serial transfer scheme has been put into practical use.

The PCI Express I/F enables transmission and reception of data in a unit of packets. Since each packet includes information such as a header in addition to data, there is a system overhead including headers as data is turned into packets.

If a data size (length) included in each packet is made to be large, it is possible to reduce such overhead resulting from turning data into packets, and an improvement of a transfer rate can be anticipated.

On the other hand, with the PCI Express I/F, flow control is performed by credit, and a transmission side transmits data while managing the amount of remaining reception buffer of the counterparty device.

A reception side notifies the transmission side of release of the reception buffer when a process of received data is completed, and the transmission side can recognize that the amount of remaining reception buffer increases.

When the reception buffer of the counterparty device has little space, the transmission side is not able to transmit data.

Japanese Unexamined Patent Application Publication No. 2008-269282 has proposed that data transfer is performed by setting the maximum value of a data size (length) to a maximum payload size [MaxPayloadSize] that is the maximum length allowed based on the specification of the PCI Express.

As described above, if a data size (length) included in each packet is made to be large, it is possible to reduce such an overhead resulting from turning data into packets, and an enhancement of the transfer rate can be anticipated.

### SUMMARY

Japanese Unexamined Patent Application Publication No. 2008-269282, however, has a disadvantage as below, since flow control by credit is not taken into consideration.

If a data size (length) is made to be large as described above, notification of reception buffer release from the reception side to the transmission side becomes late. For this reason, there is a disadvantage in that the transmission side recognizes that the reception buffer of the counterparty device does not have a space, transfer stalls, whereby reduction in the transfer rate is entailed.

It is desirable for the disclosure to provide an information processing device, an information processing system, an information processing method, and a program which determines data size during data transfer after taking not only overhead caused by turning data into packets but also flow control by credit into consideration, and suppress reduction of the transfer rate.

According to an embodiment of the present disclosure, there is provided an information processing device which includes a serial transfer interface which performs serial transfer for data in a unit of packets between counterparty devices, a transfer control unit which performs control of data transfer of the serial transfer interface, and a transfer state monitoring unit which monitors a data transfer state including a data size being subjected to data transfer of the serial transfer interface controlled by the transfer control unit according to a set maximum data size of a transmission packet, determines and can change the maximum data size of a transmission packet to be transmitted next according to the monitored state, and supplies the determined maximum data size to the transfer control unit, and the transfer control unit performs control of data transfer of the serial transfer interface according to the maximum data size of the transmission packet supplied from the transfer state monitoring unit.

According to another embodiment of the disclosure, there is provided an information processing system which includes a transmission side device which transmits data by serial transfer, and a reception side device which receives data transmitted from the transmission side device, stores the received data in a reception buffer, and performs notification of release of the reception buffer to the transmission side device, and the transmission side device includes a serial transfer interface which performs serial transfer for data in a unit of packets between the reception side device, a transfer control unit which performs control of data transfer of the serial transfer interface, and a transfer state monitoring unit which monitors a data transfer state including a data size being subjected to data transfer of the serial transfer interface controlled by the transfer control unit according to a set maximum data size of a transmission packet, determines and can change the maximum data size of a transmission packet to be transmitted next according to the monitored state, and supplies the determined maximum data size to the transfer control unit, and the transfer control unit performs control of data transfer of the serial transfer interface according to the maximum data size of the transmission packet supplied by the transfer state monitoring unit.

According to still another embodiment of the disclosure, there is provided an information processing method which includes performing serial transfer for data in a unit of packets by a serial transfer interface between counterparty devices, performing control of data transfer of the serial transfer interface, and performing monitoring of a data transfer state in which a data transfer state including a data size being subjected to data transfer of the serial transfer interface controlled in the control of the data transfer according to a set maximum data size of a transmission packet is monitored, the maximum data size of a transmission packet to be transmitted next is determined and can be changed according to the monitored state, and the determined maximum data size is supplied to the control of the data transfer, and control of data transfer of the serial transfer interface is performed in the control of the data transfer according to the maximum data size of the transmission packet supplied from the monitoring of the data transfer state.

According to still another embodiment of the disclosure, there is provided a program which causes a computer to execute information processing including performing serial transfer for data in a unit of packets by a serial transfer interface between counterparty devices, performing control of data transfer of the serial transfer interface, and performing monitoring of a data transfer state including a data size being subjected to data transfer of the serial transfer interface controlled in the control of the data transfer according to a set maximum data size of a transmission packet is monitored, the maximum data size of a transmission packet to be transmitted next is determined and can be changed according to the monitored state, and the determined maximum data size is supplied to the control of the data transfer, and control of data transfer of the serial transfer interface is performed in the control of the transfer control according to the maximum data size of the transmission packet supplied from the monitoring of the data transfer state.

According to the embodiments of the disclosure, it is possible to determine a data size during data transfer by taking not only overhead caused by turning data into packets but also flow control by credit into consideration, and to suppress reduction of a transfer rate.

### BRIEF DESCRIPTION OF THE DRAWINGS

FIG. 1 is a diagram showing a schematic configuration example of an information processing system which is applied to a first embodiment of the present disclosure;

FIG. 2 is a diagram showing a packet configuration of PCI Express;

FIG. 3 is a diagram showing a configuration example of a transfer rate measuring circuit according to an embodiment of the disclosure;

FIG. 4 is a diagram for illustrating a transfer rate measurement process of the transfer rate measuring circuit according to the embodiment of the disclosure;

FIG. 5 is a flowchart for describing a DMA transfer process of a DMA controller according to the embodiment of the disclosure;

FIG. 6 is a flowchart for describing a process of setting a maximum data size in a first determination process of a maximum data size determination unit according to a first embodiment of the disclosure;

FIG. 7 is a flowchart for describing a process of setting a maximum data size in a second determination process of the maximum data size determination unit according to the first embodiment of the disclosure;

FIG. 8 is a flowchart for describing a process of setting a maximum data size in a third determination process of the maximum data size determination unit according to the first embodiment of the disclosure;

FIG. 9 is a diagram showing a schematic configuration example of an information processing system which is applied to a second embodiment of the disclosure;

FIG. 10 is a diagram showing a configuration example of a stall time measuring circuit according to the second embodiment of the disclosure;

FIG. 11 is a diagram for illustrating a stall time measurement process in the stall time measuring circuit according to the second embodiment of the disclosure;

FIG. 12 is a flowchart for describing a process of setting a maximum data size in a fourth determination process of a maximum data size determination unit according to the second embodiment of the disclosure;

FIG. 13 is a flowchart for describing a process of setting a maximum data size in a fifth determination process of the maximum data size determination unit according to the second embodiment of the disclosure; and

FIG. 14 is a flowchart for describing a process of setting a maximum data size in a sixth determination process of the maximum data size determination unit according to the second embodiment of the disclosure.

### DETAILED DESCRIPTION OF EMBODIMENTS

Hereinafter, embodiments of the disclosure will be described in relation to accompanying drawings.

Furthermore, description will be provided in the following order.

1. First Embodiment (First Configuration Example of Information Processing System)

2. Second Embodiment (Second Configuration Example of Information Processing System)

### 1. First Embodiment

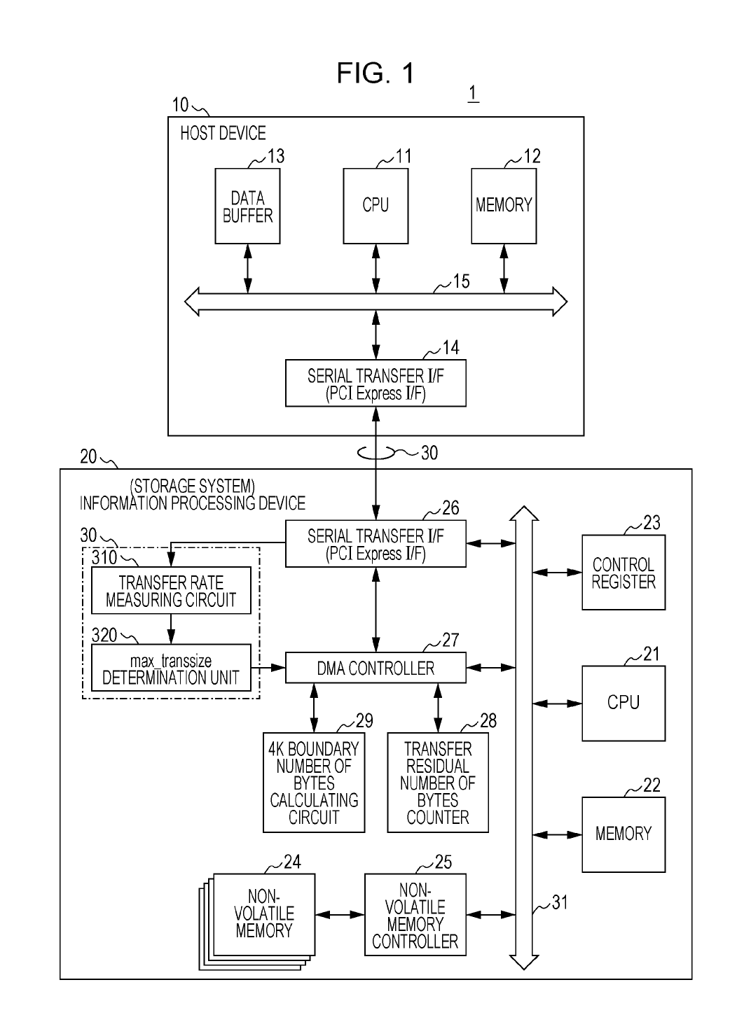

FIG. 1 is a diagram showing a schematic configuration example of an information processing system which is applied to a first embodiment of the present disclosure.

The information processing system 1 is configured that host equipment 10 and an information processing device 20 are connected to by a high-speed serial transfer interface (I/F) bus 30.

As the serial transfer I/F, for example, a high-speed bus of PCI (Peripheral Component Interconnect) Express is applied.

In the embodiment, the information processing device 20 is formed as a storage system mounted with a non-volatile memory such as a flash memory, and formed as storage equipment which can be attachably and detachably installed in, for example, the host equipment 10.

The host equipment 10 includes equipment of a personal computer, a digital still camera, a digital video camera, an audio recorder, or the like.

The host equipment 10 includes a CPU 11, a memory 12, a data buffer 13, and an external serial transfer I/F, for example, a PCU Express I/F 14.

The CPU 11 is connected to the memory 12, the data buffer 13, and the external serial transfer I/F 14 to one another via a bus 15.

The memory 12 includes a ROM for program storage, a RAM that is a working memory, and the like.

The data buffer 13 functions as a reception buffer when the host equipment 10 functions as a reception side device on the system.

The host equipment 10 when functioning as a reception side device receives data transmitted from the information processing device 20 that is a transmission side device, stores the received data in the data buffer 13, performs notification of release of the data buffer 13 to the information processing device 20 when a process ends.

The external serial transfer I/F 14 performs serial transfer of data in a unit of packets between the information processing device 20 according to control commands of the CPU 11.

The information processing device 20 includes a CPU 21, a memory 22, a control register 23, a non-volatile memory 24 such as a flash memory, a non-volatile memory controller 25, and an external serial transfer I/F 26, for example, a PCI Express I/F 26.

The information processing device 20 includes a DMA (Direct Memory Access) controller 27, a transfer residual number of bytes counter 28 as a transfer residual data size acquisition unit, a 4k boundary number of bytes calculating circuit 29 as an address boundary data size acquisition unit, and a transfer state monitoring unit 30.

The DMA controller 27 functions as a transfer control unit.

The CPU 21 is connected to the memory 22, the control register 23, the non-volatile memory controller 25, the external serial transfer I/F (for example, a PCI Express I/F) 26, and the DMA controller 27 to one another via a bus 31.

The memory 22 includes a ROM for program storage, a RAM that is a working memory, and the like.

The control register 23 receives commands from the host equipment 10 through the external serial transfer I/F (for example, a PCI Express I/F) 26. The commands from the host equipment 10 include a writing command and a reading command for the non-volatile memory 24.

The CPU 21 performs setting of the DMA controller 27, and the non-volatile memory controller 25 according to content of setting for the control register 23, and starts processes.

The non-volatile memory 24 is constituted by, for example, a NOR-type or a NAND-type flash memory (non-volatile memory).

The external serial transfer I/F (for example, a PCI Express I/F) 26 transmits and receives data with the host equipment 10 by serial transfer in a unit of packets, under the control of the DMA controller 27, which follows control commands of the CPU 21.

When, for example, a PCI Express I/F is applied as the external serial transfer I/F, it is necessary to perform exchange of data taking the following restrictions into consideration.

As one restriction, it is necessary to consider transfer performance of the host equipment 10 to the information processing device 20, for example, a maximum payload size (Max Payload Size) indicating a maximum size of payload in the case of writing, and to perform exchange of data so as not to exceed the size.

In addition, as another restriction, generation of a packet which makes access spanning predetermined address boundaries is prohibited.

For example, the specification of the PCI Express prohibits generation of a packet which makes access spanning 4k address boundaries (page boundaries in a personal computer). Thus, it is necessary not to perform transfer spanning the 4k address boundaries.

The DMA controller 27 as a transfer control unit performs data transfer control of the serial transfer I/F 26 according to the maximum data size information of a transmission packet supplied by the transfer residual number of bytes counter 28, the 4k boundary number of bytes calculating circuit 29 and the transfer state monitoring unit 30.

The DMA controller 27 determines the data size of the transmission packet based on information obtained from the transfer residual number of bytes counter 28, the 4k boundary number of bytes calculating circuit 29 and the transfer state monitoring unit 30, and performs a packet transmission request to the serial transfer I/F 26.

The DMA controller 27 determines the data size of the transmission packet as follows based on whether or not a first data size obtained by the residual number of bytes counter 28 or a second data size obtained by the 4k boundary number of bytes calculating circuit 29 is smaller than the set maximum data size.

When either of the sizes is smaller than the maximum data size, the DMA controller 27 sets the smaller one of the first and the second data sizes to the data size of the transmission packet.

When either of the sizes is not smaller than the maximum data size, the DMA controller 27 sets the maximum data size supplied from the transfer state monitoring unit 30 to the data size of the transmission packet.

The first data size is applied with DMA transfer residual number of bytes remain_size by the transfer residual number of bytes counter 28, and the second data size is applied with the number of bytes bound4k_diff to the 4k byte boundary by the 4k boundary number of bytes calculating circuit 29.

Direct Memory Access is direct transfer of data between a memory and a memory or a memory and an I/O device, not by a group of machine language instructions. The DMA controller is a controller for controlling a DMA function.

Data transfer using the DMA function is performed by using descriptor which describes data transfer control information such as data transfer addresses and data transfer size.

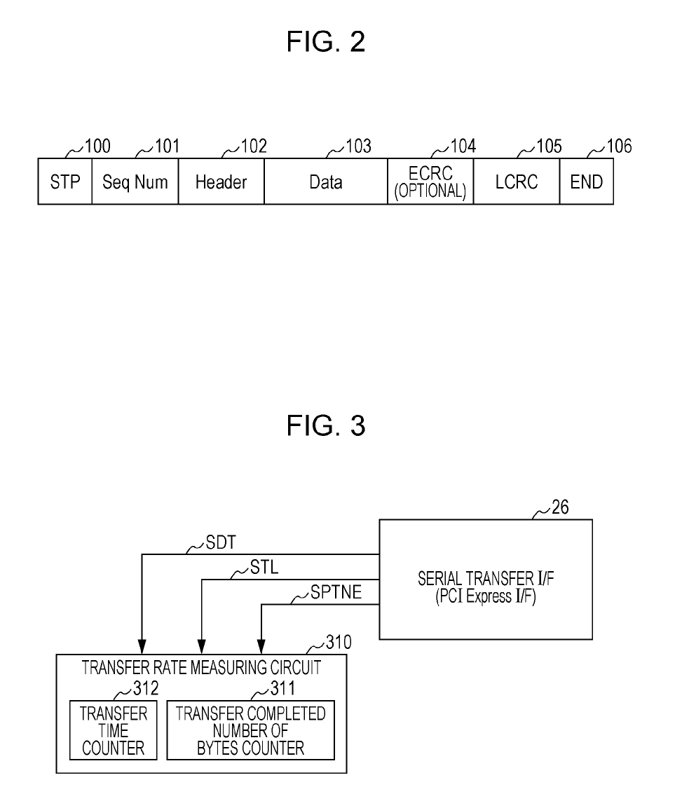

FIG. 2 is a diagram showing a packet configuration of the PCI Express.

In FIG. 2, a STP 100 and an END 106 indicate the head and the tail of each packet.

A Seq Num 101 indicates the sequence number, a Header 102 indicates the header, and a Data 103 indicates the main body of data transferred, respectively.

An ECRC 104 and an LCRC 105 indicates CRC for erroneous detection, and adding the ECRC is optional.

As shown in FIG. 2, the packet includes additional information such as the header 102 in addition to the main body of the Data 103. If the size of the Data 103 increases, it is possible to reduce influence of overhead resulting from turning data into packets.

The transfer residual number of bytes counter 28 as a transfer residual data size acquisition unit counts the number of remaining bytes of transferred data, and supplies the result to the DMA controller 27.

The 4k boundary number of bytes calculating circuit 29 as an address boundary data size calculates the number of bytes to the 4k byte boundary, and supplies the result to the DMA controller 27.

The transfer state monitoring unit 30 monitors a data transfer state including data size (data amount) during data transfer execution of the external serial transfer I/F 26 controlled by the DMA controller 27 according to the set maximum data size of the transmission packet.

The transfer state monitoring unit 30 can determine and change the maximum data size of a transmission packet to be transmitted to the next according to the monitored state, and supplies the determined maximum data size to the DMA controller 27.

The transfer state monitoring unit 30 of the embodiment is configured to include a transfer rate measuring circuit 310 as a transfer rate acquisition unit and a maximum data size determination unit 320.

The transfer rate measuring circuit 310 measures (acquires) the transfer rate from the data transfer state information including the data size during the data transfer execution of the serial transfer I/F 26.

The data transfer state information includes a DMA transferring signal SDT indicating that the serial transfer I/F 26 is performing DMA transfer, a transferring packet data size (length) signal STL, and a packet transfer normal end signal SPTNE indicating whether or not packet transfer has ended normally.

FIG. 3 is a diagram showing a configuration example of the transfer rate measuring circuit according to the embodiment of the disclosure.

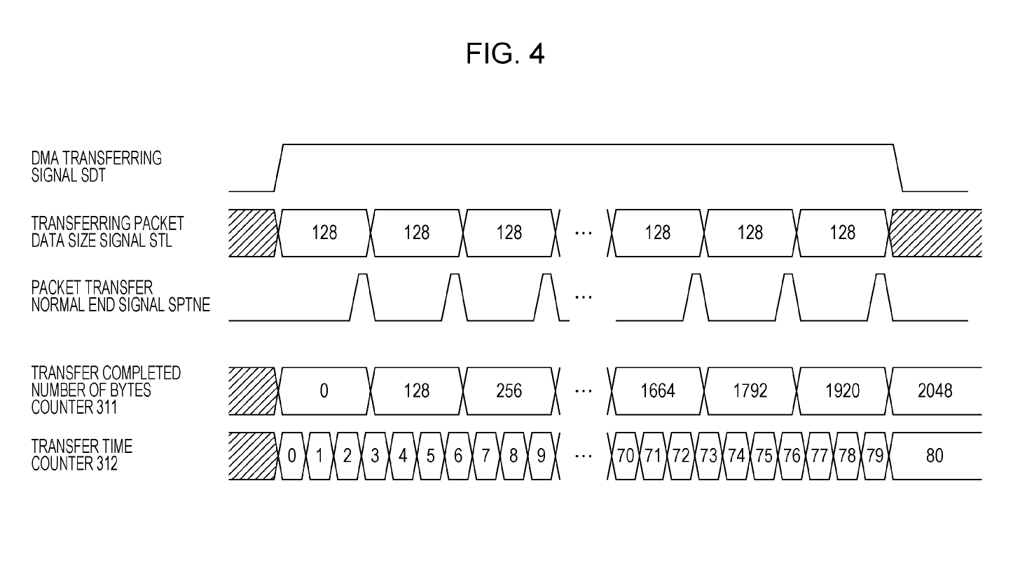

FIG. 4 is a diagram for illustrating a transfer rate measurement process of the transfer rate measuring circuit according to the embodiment of the disclosure.

The transfer rate measuring circuit 310 of FIG. 3 includes a transfer completed number of bytes counter 311 and a transfer time counter 312.

Herein, as the serial transfer I/f 26, for example, the PCI Express I/F as described above is applied.

Hereinbelow, the transfer rate measurement process according to the embodiment will be described in relation to FIGS. 3 and 4.

The serial transfer I/F 26 notifies the transfer rate measuring circuit 310 of the DMA transferring signal SDT indicating whether or not DMA transfer is being performed, the transferring packet data size (length) signal STL, and the packet transfer normal end signal SPTNE indicating whether or not packet transfer has ended normally.

The serial transfer I/F 26 receives a data transfer request signal S27 from the DMA controller 27 and sets data to be being transferred and the DMA transferring signal SDT to an active high level (H level). The serial transfer I/F 26 sets the DMA transferring signal SDT to a non-active low level (L level) if data transfer is ended.

The serial transfer I/F 26 sets the packet transfer normal end signal SPTNE to a high level (H) every time packet transfer is ended normally.

The transfer completed number of bytes counter 311 resets a count value (clears to 0) when the DMA transferring signal SDT is switched from the L level to the H level.

The transfer completed number of bytes counter 311, for example, increases counting by transferring packet data size (length) every time the packet transfer normal end signal SPTNE is at the H level.

The transfer time counter 312 resets a count value (clears to 0) when the DMA transferring signal SDT is switched from the L level to the H level. The transfer time counter 312 increases counting during DMA transfer.

The transfer time counter 312 stops the counting operation when the DMA transferring signal SDT is switched from the H level to the L level.

Then, the transfer rate measuring circuit 310 can obtain a transfer rate by dividing the count value of the transfer completed number of bytes counter 311 by the count value of the transfer time counter 312 when the DMA transferring signal SDT is switched from the H level to the L level.

The transfer rate measuring circuit 310 supplies the acquired transfer rate to the maximum data size determination unit 320.

The maximum data size determination unit 320 has a function of determining the maximum data size of a transmission packet to be transmitted based on the relationship between the transmission rate information acquired by the transfer rate measuring circuit 310 and the set maximum data size max_transsize.

Then, the maximum data size determination unit 320 has a function of changing the maximum data size of a transmission packet and supplies the changed maximum data size max_transsize to the DMA controller 27.

The DMA controller 27 performs transfer control of the serial transfer I/F 26 based on the maximum data size max_transsize supplied from the maximum data size determination unit 320 based on a predetermined condition.

The maximum data size determination unit 320 has a function of determining whether or not the transfer rate acquired by the transfer rate measuring circuit 310 after the maximum data size of the transmission packet is changed has improved.

When the transfer rate has improved, the maximum data size determination unit 320 further changes the maximum data size of the transmission packet (by reducing or raising the size), and determines whether or not the transfer rate has improved again.

When the transfer rate has improved after a reduction in the maximum data size, the maximum data size determination unit 320 assumes that a decrease in the transfer rate is lessened due to a lack of credit, and performs the same process by further reducing the maximum data size of the transmission packet. When the transfer rate has improved after an increase in the maximum data size, the maximum data size determination unit 320 determines that the influence of overhead resulting from turning data into packets is lessened, and performs the same process by further increasing the maximum data size of the transmission packet.

When the transfer rate has not improved after the reduction in the maximum data size, the maximum data size determination unit 320 determines that the influence of overhead resulting from turning data into packets mainly contributed thereto. When the transfer rate has not improved after the increase in the maximum data size, the maximum data size determination unit 320 has functions of determining that a reduction in the transfer rate has occurred due to the lack of credit, and putting the data size back to the maximum data size before the change (for example, to the previous maximum data size).

In the present first embodiment, the maximum data size determination unit 320 of the transfer state monitoring unit 30 performs, for example, a first to a third determination processes shown below.

After the overview of the first to the third determination processes are described, specific processes will be described in relation to a flowchart.

Furthermore, in the embodiment, the set maximum data size max_transsize of the transmission packet is defined with a minimum value min_transsize that is the minimum value and a maximum value limit_transsize that is the maximum value of the set range in advance.

### [Overview of First Determination Process]

In the first determination process, the maximum data size determination unit 320 sets the maximum payload size MaxPayloadSize defined as the initial value of the maximum data size max_transsize.

The maximum data size determination unit 320 determines whether or not the current maximum data size of the transmission packet has reached the minimum value based on the relationship between the transfer rate information acquired by the transfer rate measuring circuit 310 and the minimum value min_transsize of the maximum data size.

When the current maximum data size has not reached the minimum value, the maximum data size determination unit 320 reduces the maximum data size of the transmission packet by a predetermined size, and determines whether or not the transfer rate acquired by the transfer rate measuring circuit 310 has improved after the reduction in the maximum data size.

When the transfer rate has improved, the maximum data size determination unit 320 further reduces the maximum data size of the transmission packet with a condition that the current maximum data size has not reached the minimum value.

Then, the maximum data size determination unit 320 determines whether or not the transfer rate acquired by the transfer rate measuring circuit 310 has improved after the reduction in the maximum data size, and when the transfer rate has not improved, and puts the data size back to the maximum data size before the change.

### [Overview of Second Determination Process]

In the second determination process, the maximum data size determination unit 320 sets minimum value min_transsize of the maximum data size defined as the initial value of the maximum data size max_transsize.

The maximum data size determination unit 320 determines whether or not the current maximum data size of the transmission packet has reached the maximum value based on the relationship between the transfer rate information acquired by the transfer rate measuring circuit 310 and the maximum value limit_transsize of the maximum data size.

When the current maximum data size has not reached the maximum value, the maximum data size determination unit 320 increases the maximum data size of the transmission packet by a predetermined size, and determines whether or not the transfer rate acquired by the transfer rate measuring circuit 310 has improved after the increase in the maximum data size.

When the transfer rate has improved, the maximum data size determination unit 320 further increases the maximum data size of the transmission packet with a condition that the current maximum data size has not reached the maximum value.

Then, the maximum data size determination unit 320 determines whether or not the transfer rate acquired by the transfer rate measuring circuit 310 has improved after the increase in the maximum data size, and when the transfer rate has not improved, and puts the data size back to the maximum data size before the change.

### [Overview of Third Determination Process]

In the third determination process, the maximum data size determination unit 320 sets maximum data size max_transsize to the initial value init_transsize set in advance.

The maximum data size determination unit 320 determines whether or not the current maximum data size of the transmission packet has reached the maximum value based on the relationship between the transfer rate information acquired by the transfer rate measuring circuit 310 and the maximum value limit_transsize of the maximum data size.

When the current maximum data size has not reached the maximum value, the maximum data size determination unit 320 increases the maximum data size of the transmission packet by a predetermined size, and determines whether or not the transfer rate acquired by the transfer rate measuring circuit 310 has improved after the increase in the maximum data size.

When the transfer rate has improved, the maximum data size determination unit 320 performs a first process, and when the current maximum data size has reached the above maximum value, or when the transfer rate has not improved, the unit puts the data size back to the maximum data size before the change to perform a second process.

### [First Process in Third Determination Process]

As the first process, the maximum data size determination unit 320 determines whether or not the current maximum data size of the transmission packet has reached the maximum value limit_transsize.

When the current maximum data size has not reached the maximum value, the maximum data size determination unit 320 increases the maximum data size of the transmission packet by a predetermined size, and determines whether or not the transfer rate acquired by the transfer rate measuring circuit 310 has improved after the increase in the maximum data size.

When the transfer rate has improved, the maximum data size determination unit 320 further increases the maximum data size of the transmission packet with a condition that the current maximum data size has not reached the maximum value.

Then, the maximum data size determination unit 320 determines whether or not the transfer rate acquired by the transfer rate measuring circuit 310 has improved after the increase in the maximum data size, and when the transfer rate has not improved, the unit puts the data size back to the maximum data size before the change.

### [Second Process in Third Determination Process]

As the second process, the maximum data size determination unit 320 determines whether or not the current maximum data size of the transmission packet has reached the minimum value min_transsize.

When the current maximum data size has not reached the minimum value, the maximum data size determination unit 320 reduces the maximum data size of the transmission packet by a predetermined size, and determines whether or not the transfer rate acquired by the transfer rate measuring circuit 310 has improved after the reduction in the maximum data size.

When the transfer rate has improved, the maximum data size determination unit 320 further reduces the maximum data size of the transmission packet with a condition that the current maximum data size has not reached the minimum value.

Then, the maximum data size determination unit 320 determines whether or not the transfer rate acquired by the transfer rate measuring circuit 310 has improved after the reduction in the maximum data size, and when the transfer rate has not improved, the unit puts the data size back to the maximum data size before the change.

Furthermore, the first, the second, and the third determination process functions can be included individually, in plural or all together, or can be applied in appropriate combination.

Next, specific example of the first, the second, and the third determination processes will be described in relation to flowcharts.

Before the first to the third determination processes are described herein, first, a DMA transfer process by the DMA controller 27 will be described.

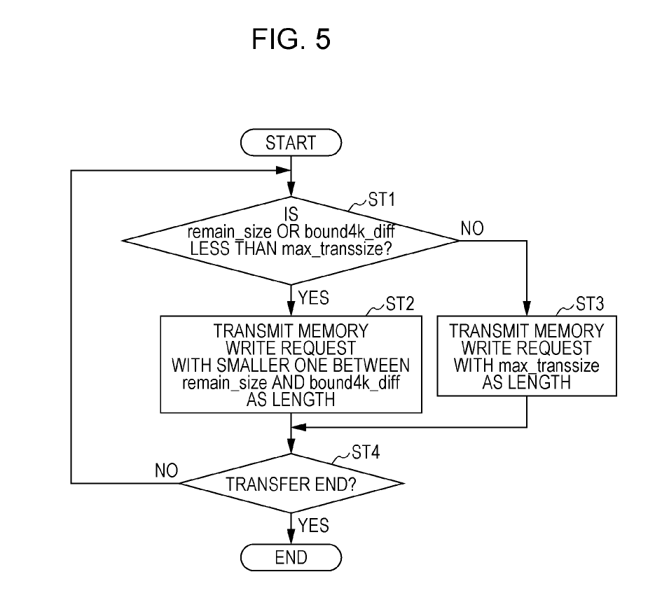

FIG. 5 is a flowchart for describing a DMA transfer process of the DMA controller according to the embodiment.

The DMA controller 27 determines the data size of a transmission packet based on information from the transfer residual number of bytes counter 28, the 4k boundary number of bytes calculating circuit 29 and the maximum data size determination unit 320, and performs a packet transmission request to the serial transfer I/F 26.

The DMA controller 27 determines whether or not the DMA transfer residual number of bytes remain_size by the transfer residual number of bytes counter 28 or the number of bytes to the 4k byte boundary bound4k_diff by the 4k boundary number of bytes calculating circuit 29 satisfies a predetermined condition.

In other words, the DMA controller 27 determines whether or not the DMA transfer residual number of bytes remain_size or the number of bytes to the 4k byte boundary bound4k_diff is less than the maximum data size max_transsize (ST1).

If either of them is determined to be less than the maximum data size in Step ST1, the DMA controller 27 performs a process below.

The DMA controller 27 transmits a memory write request setting a smaller one between the DMA transfer residual number of bytes remain_size and the number of bytes to the 4k byte boundary bound4k_diff as a data size (ST2).

Furthermore, the memory write request is a packet used in data transmission.

If either of them is determined to be not less than the maximum data size in Step ST1, the DMA controller 27 performs a process below.

The DMA controller 27 transmits a memory write request setting the maximum data size max_transsize supplied from the maximum data size determination unit 320 as a data size (length) (ST3).

The DMA controller 27 repeats the processes from Steps ST1 to ST3 until the transfer ends (ST4).

### [Specific Setting Example of Maximum Data Size in First Determination Process]

Next, a process of setting the maximum data size max_transsize in the first determination process by the maximum data size determination unit 320 according to the first embodiment will be described.

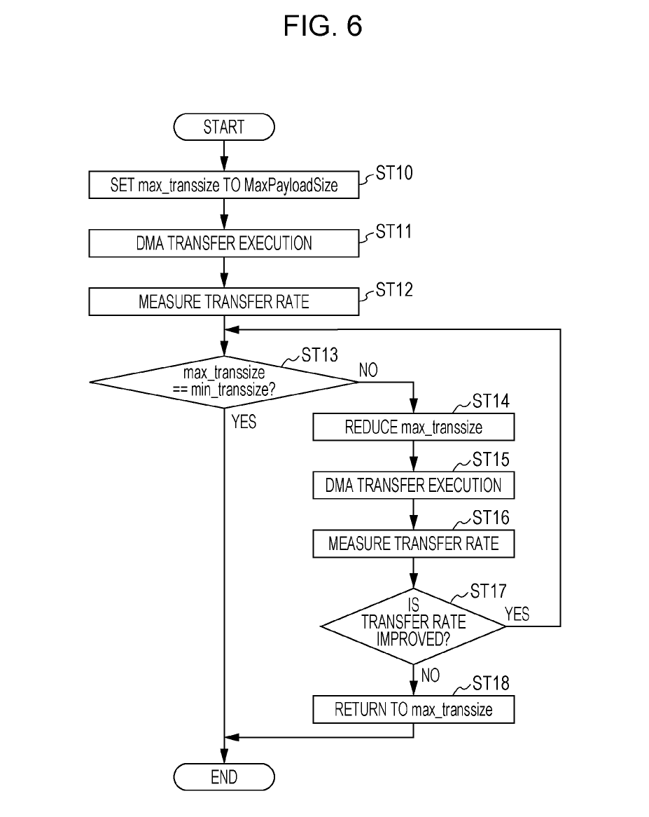

FIG. 6 is a flowchart for describing a process of setting the maximum data size max_transsize in the first determination process of the maximum data size determination unit according to the first embodiment.

The maximum data size determination unit 320 sets the maximum payload size (MaxPayloadSize) defined as the initial value of the maximum data size max_transsize (ST10).

Under the control of the DMA controller 27 based on the set maximum data size, DMA transfer is executed through the serial transfer I/F 26 (ST11), and the transfer rate at that moment is measured by the transfer rate measuring circuit 310 (ST12).

The maximum data size determination unit 320 determines whether or not the current maximum data size of the transmission packet has reached the minimum value based on the relationship between the transfer rate information acquired by the transfer rate measuring circuit 310 and the minimum value min_transsize of the maximum data size (ST13).

When the current maximum data size has not reached the minimum value, the maximum data size determination unit 320 reduces the maximum data size of the transmission packet by a predetermined size (ST14).

Under the control of the DMA controller 27 based on the reduced and set maximum data size, DMA transfer is executed through the serial transfer I/F 26 (ST15), and the transfer rate at that moment is measured by the transfer rate measuring circuit 310 again (ST16).

Then, the maximum data size determination unit 320 determines whether or not the transfer rate acquired by the transfer rate measuring circuit 310 has improved further than the transfer rate previously measured after the reduction in the maximum data size. (ST17).

When the transfer rate has improved, the maximum data size determination unit 320 determines that the reduction in the transfer rate is lessened due to the lack of credit, the process returns to the process of Step ST13, and the processes of Steps ST14 to ST17 are repeated until the current maximum data size reaches the minimum value.

Then, when the transfer rate has not improved in Step ST17, the maximum data size determination unit 320 determines the influence of overhead resulting from turning the data into packets mainly contributed thereto, and the data size is put back to the maximum data size before the change (for example, previous data size) (ST18).

### [Specific Setting Example of Maximum Data Size in Second Determination Process]

Next, a process of setting the maximum data size max_transsize in the second determination process by the maximum data size determination unit 320 according to the first embodiment will be described.

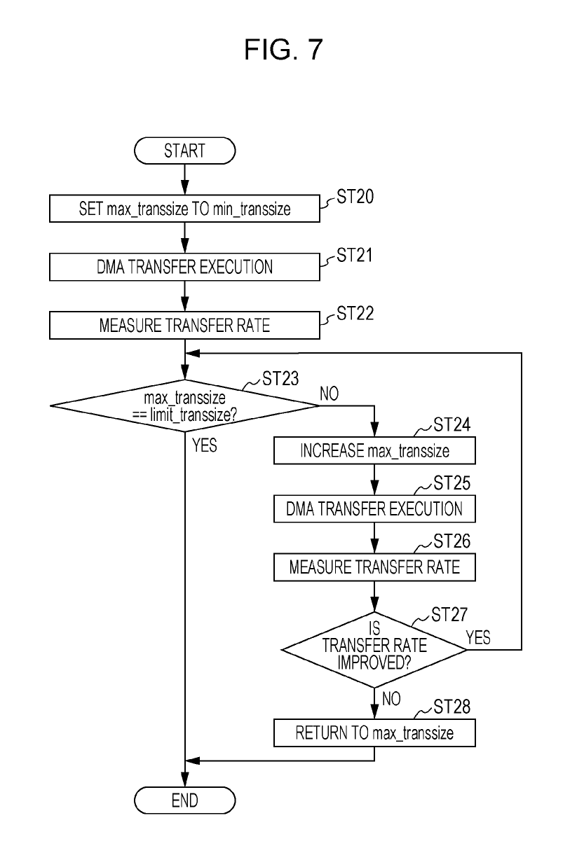

FIG. 7 is a flowchart for describing a process of setting the maximum data size max_transsize in the second determination process of the maximum data size determination unit according to the first embodiment.

The maximum data size determination unit 320 sets the minimum value min_transsize of the maximum data size defined as the initial value of the maximum data size max_transsize (ST20).

Under the control of the DMA controller 27 based on the set maximum data size, DMA transfer is executed through the serial transfer I/F 26 (ST21), and the transfer rate at that moment is measured by the transfer rate measuring circuit 310 (ST22).

The maximum data size determination unit 320 determines whether or not the current maximum data size of the transmission packet has reached the maximum value based on the relationship between the transfer rate information acquired by the transfer rate measuring circuit 310 and the maximum value limit_transsize of the maximum data size (ST23).

When the current maximum data size has not reached the maximum value, the maximum data size determination unit 320 increases the maximum data size of the transmission packet by a predetermined size (ST24).

Under the control of the DMA controller 27 based on the increased and set maximum data size, DMA transfer is executed through the serial transfer I/F 26 (ST25), and the transfer rate at that moment is measured by the transfer rate measuring circuit 310 again (ST26).

Then, the maximum data size determination unit 320 determines whether or not the transfer rate acquired by the transfer rate measuring circuit 310 has improved further than the transfer rate previously measured after the increase in the maximum data size. (ST27).

When the transfer rate has improved, the maximum data size determination unit 320 determines that the influence of overhead resulting from turning the data into packets is lessened, the process returns to the process of Step ST23, and the processes of Steps ST24 to ST27 are repeated until the current maximum data size reaches the maximum value.

Then, when the transfer rate has not improved in Step ST27, the maximum data size determination unit 320 determines that the reduction in the transfer rate occurred due to the lack of credit, and puts the data size back to the maximum data size before the change (for example, previous data size) (ST28).

### [Specific Setting Example of Maximum Data Size in Third Determination Process]

Next, a process of setting the maximum data size max_transsize in the third determination process by the maximum data size determination unit 320 according to the first embodiment will be described.

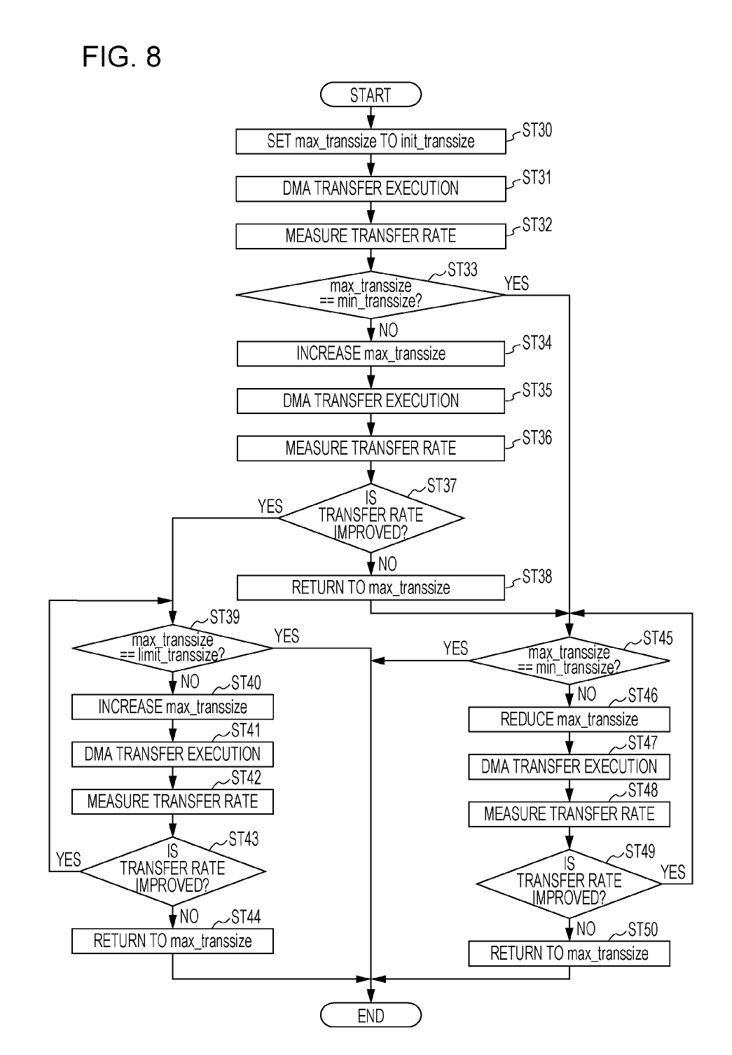

FIG. 8 is a flowchart for describing a process of setting the maximum data size max_transsize in the third determination process by the maximum data size determination unit according to the first embodiment.

The maximum data size determination unit 320 sets the maximum data size max_transsize to the initial value init_transsize set in advance (ST30).

Under the control of the DMA controller 27 based on the set maximum data size, DMA transfer is executed through the serial transfer I/F 26 (ST31), and the transfer rate at that moment is measured by the transfer rate measuring circuit 310 (ST32).

The maximum data size determination unit 320 determines whether or not the current maximum data size of the transmission packet has reached the maximum value based on the relationship between the transfer rate information acquired by the transfer rate measuring circuit 310 and the maximum value limit_transsize of the maximum data size (ST33).

When the current maximum data size has not reached the maximum value, the maximum data size determination unit 320 increases the maximum data size of the transmission packet by a predetermined size (ST34).

Under the control of the DMA controller 27 based on the increased and set maximum data size, DMA transfer is executed through the serial transfer I/F 26 (ST35), and the transfer rate at that moment is measured by the transfer rate measuring circuit 310 again (ST36).

Then, the maximum data size determination unit 320 determines whether or not the transfer rate acquired by the transfer rate measuring circuit 310 has improved further than the transfer rate previously measured after the increase in the maximum data size. (ST37).

When the transfer rate has improved, the maximum data size determination unit 320 performs the first process, and when the current maximum data size has reached the above-described maximum value (ST33) or when the transfer rate has not improved, the unit puts the data size back to the maximum data size before the change (ST38) to perform the second process.

### [Specific Example of First Process in Third Determination Process]

As the first process, the maximum data size determination unit 320 determines whether or not the current maximum data size of the transmission packet has reached the maximum value limit_transsize (ST39).

When the current maximum data size has not reached the maximum value, the maximum data size determination unit 320 increases the maximum data size of the transmission packet by a predetermined size (ST40).

Under the control of the DMA controller 27 based on the increased and set maximum data size, DMA transfer is executed through the serial transfer I/F 26 (ST41), and the transfer rate at that moment is measured by the transfer rate measuring circuit 310 again (ST42).

Then, the maximum data size determination unit 320 determines whether or not the transfer rate acquired by the transfer rate measuring circuit 310 has improved further than the transfer rate previously measured after the increase in the maximum data size (ST43).

When the transfer rate has improved, the maximum data size determination unit 320 determines that the influence of overhead resulting from turning the data into packets is lessened, the process returns to the process of Step ST39, and the processes of Steps ST39 to ST43 are repeated until the current maximum data size reaches the maximum value.

Then, when the transfer rate has not improved in Step ST43, the maximum data size determination unit 320 determines that the reduction in the transfer rate occurred due to the lack of credit, and puts the data size back to the maximum data size before the change (for example, the previous data size) (ST44).

### [Specific Example of Second Process in Third Determination Process]

As the second process, the maximum data size determination unit 320 determines whether or not the current maximum data size of the transmission packet has reached the minimum value min_transsize (ST45).

When the current maximum data size has not reached the minimum value, the maximum data size determination unit 320 reduces the maximum data size of the transmission packet by a predetermined size (ST46).

Under the control of the DMA controller 27 based on the reduced and set maximum data size, DMA transfer is executed through the serial transfer I/F 26 (ST47), and the transfer rate at that moment is measured by the transfer rate measuring circuit 310 again (ST48).

Then, the maximum data size determination unit 320 determines whether or not the transfer rate acquired by the transfer rate measuring circuit 310 has improved further than the transfer rate previously measured after the reduction in the maximum data size (ST49).

When the transfer rate has improved, the maximum data size determination unit 320 determines that reduction in the transfer rate caused by the lack of credit is lessened, the process returns to the process of Step ST45, and the processes of Steps ST45 to ST49 are repeated until the current maximum data size reaches the minimum value.

Then, when the transfer rate has not improved in Step ST49, the maximum data size determination unit 320 determines that the influence of overhead resulting from turning the data into packets contributed thereto, and puts the data size back to the maximum data size before the change (for example, the previous data size) (ST50).

### 2. Second Embodiment

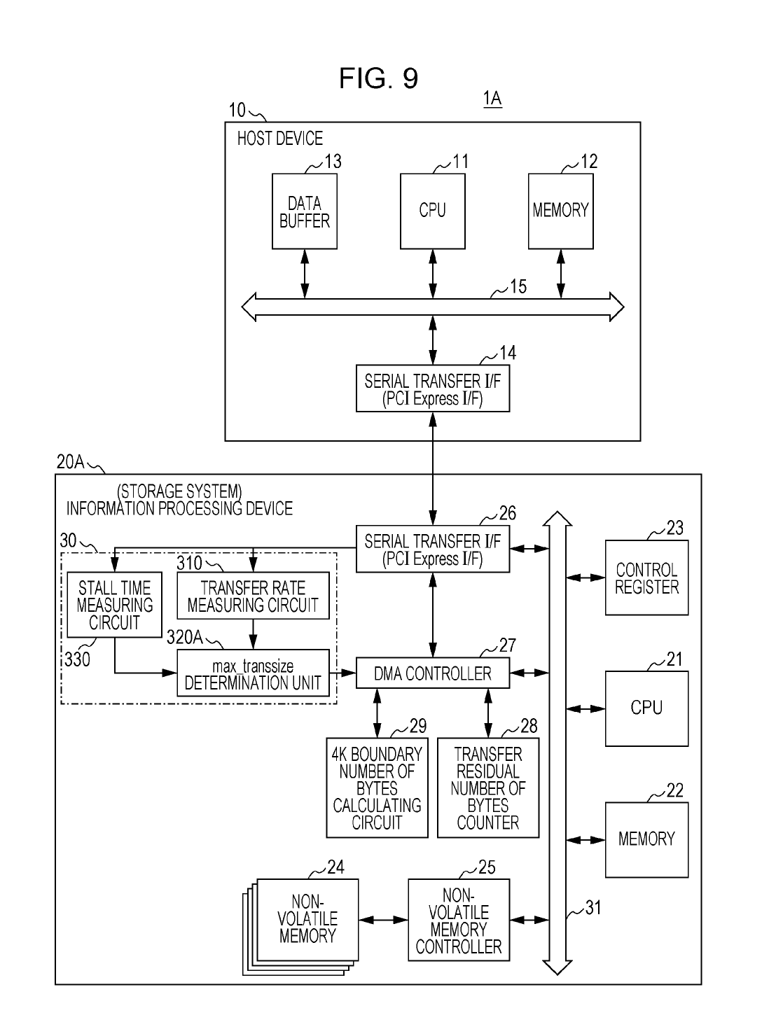

FIG. 9 is a diagram showing a schematic configuration example of an information processing system which is applied to a second embodiment of the disclosure.

The difference with an information processing system 1A according to the second embodiment from the information processing system 1 according to the first embodiment is the following.

The information processing system 1A is added with a stall time (Tstall) measuring circuit 330 which measures a time that data transmission stalls due to the lack of credit in a transfer state monitoring unit 30A of an information processing device 10A.

Accordingly, the maximum data size determination unit 320 performs a determination process of the maximum data size using information of occurrence or non-occurrence of stall acquired by the stall time measuring circuit 330 in addition to a transfer rate acquired by the transfer rate measuring circuit 310.

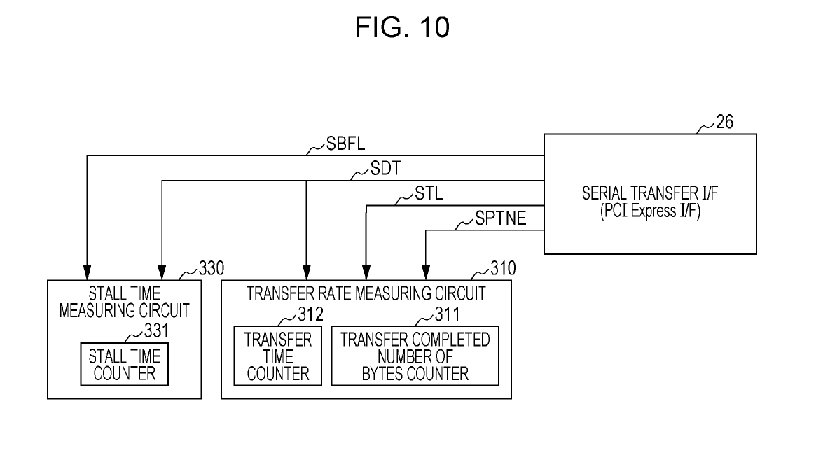

FIG. 10 is a diagram showing a configuration example of the stall time measuring circuit according to the embodiment.

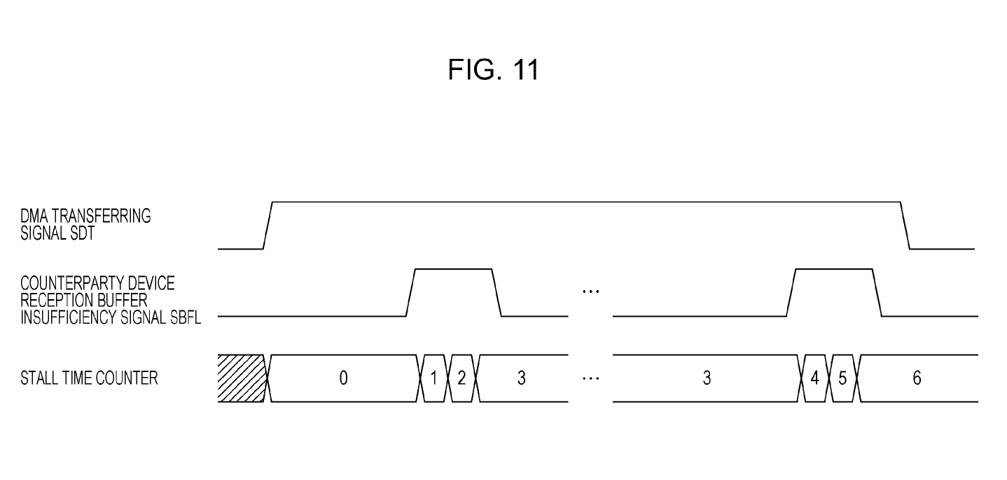

FIG. 11 is a diagram for illustrating a stall time measurement process in the stall time measuring circuit according to the embodiment.

The stall time measuring circuit 330 of FIG. 10 includes a stall time (Tstall) counter 331.

When it is difficult to transmit packets due to insufficient reception buffer of the host equipment 10 that is the other equipment during DMA transfer, the serial transfer I/F (PCI Express I/F) 26 sets a reception buffer insufficiency signal SBFL of the other equipment to the H level. The serial transfer I/F 26 sets the reception buffer insufficiency signal SBFL to the L level after the reception buffer insufficiency is resolved.

The stall time measuring circuit 330 resets the count value of the stall time (Tstall) counter 331 (clears to 0) when the DMA transferring signal SDT is switched from the L level to the H level.

For the period in which the reception buffer insufficiency signal SBFL becomes at the H level during the DMA transfer, the stall time (Tstall) measuring circuit 330 turns the stall time (Tstall) counter 331 to increment.

When the DMA transferring signal is switched from the H level to the L level, the stall time (Tstall) measuring circuit 330 sets the count value of the stall time (Tstall) counter 331 to a stall time (Tstall) measurement value.

A maximum data size determination unit 320A according to the second embodiment can determine the maximum data size of a transmission packet to be transmitted based on measurement result of the stall time measuring circuit 330 and the relationship between transfer rate information acquired by the transfer rate acquisition unit and the set maximum data size, and change the maximum data size of the transmission packet.

In the second embodiment, the maximum data size determination unit 320A of the transfer state monitoring unit 30A performs, for example, a fourth to a sixth determination processes shown below.

After the overview of the fourth to the sixth determination processes is described, specific processes will be described in relation to flowcharts.

Furthermore, in the present embodiment, the set maximum data size max_transsize of the transmission packet is defined with the minimum value min_transsize that is the minimum value and the maximum value limit_transsize that is the maximum value in a set range in advance.

### [Overview of Fourth Determination Process]

In the fourth determination process, the maximum data size determination unit 320A sets the maximum payload size MaxPayloadSize defined as the initial value of the maximum data size max_transsize.

The maximum data size determination unit 320A determines whether or not stall has occurred based on the measurement result of the stall time measuring circuit 330, and when stall has occurred, the unit performs the next process.

The maximum data size determination unit 320A determines whether or not the current maximum data size of the transmission packet has reached the minimum value based on the relationship between the transfer rate information acquired by the transfer rate measuring circuit 310 and the minimum value min_transsize of the maximum data size.

When the current maximum data size has not reached the minimum value, the maximum data size determination unit 320A reduces the maximum data size of the transmission packet by a predetermined size.

The maximum data size determination unit 320A determines whether or not the transfer rate measured by the transfer rate measuring circuit 310 has improved after the reduction in the maximum data size.

When the transfer rate has improved, the maximum data size determination unit 320A determines whether or not stall has occurred. When stall has occurred, the maximum data size determination unit 320A further reduces the maximum data size of the transmission packet with a condition that the current maximum data size has not reached the minimum value.

Then, the maximum data size determination unit 320A determines whether or not the transfer rate acquired by the transfer rate measuring circuit 310 has improved after the reduction in the maximum data size.

When the transfer rate has not improved, the maximum data size determination unit 320A puts the data size back to the maximum data size before the change (for example, the previous data size).

When stall has not occurred, the maximum data size determination unit 320A determines that the reduction in the transfer rate by flow control is resolved, and finishes the process.

### [Overview of Fifth Determination Process]

In the fifth determination process, the maximum data size determination unit 320A sets the minimum value min_transsize defined as the initial value of the maximum data size max_transsize.

The maximum data size determination unit 320A determines whether or not stall has occurred based on the measurement result of the stall time measuring circuit 330, and when stall has not occurred, the unit performs the next process.

The maximum data size determination unit 320A determines whether or not the current maximum data size of the transmission packet has reached the maximum value based on the relationship between the transfer rate information acquired by the transfer rate measuring circuit 310 and the maximum value limit_transsize of the maximum data size.

When the current maximum data size has not reached the maximum value, the maximum data size determination unit 320A increases the maximum data size of the transmission packet by a predetermined size.

The maximum data size determination unit 320A determines whether or not the transfer rate measured by the transfer rate measuring circuit 310 has improved after the increase in the maximum data size.

When the transfer rate has improved, the maximum data size determination unit 320A determines whether or not stall has occurred. When stall has not occurred, the maximum data size determination unit 320A further increases the maximum data size of the transmission packet with a condition that the current maximum data size has not reached the maximum value.

Then, the maximum data size determination unit 320A determines whether or not the transfer rate acquired by the transfer rate measuring circuit 310 has improved after the increase in the maximum data size.

When the transfer rate has not improved, the maximum data size determination unit 320A puts the data size back to the maximum data size before the change (for example, the previous data size).

When stall has occurred, the maximum data size determination unit 320A determines that it is difficult to expect improvement in the transfer rate even after the increase in the maximum data size, and finishes the process.

### [Overview of Sixth Determination Process]

In the sixth determination process, the maximum data size determination unit 320A sets the maximum data size max_transsize to the initial value init_transsize set in advance.

The maximum data size determination unit 320A determines whether or not stall has occurred based on the measurement result of the stall time measuring circuit 330, and when stall has not occurred, the unit performs the third process, and when stall has occurred, the unit performs the fourth process.

### [Third Process in Sixth Determination Process]

As the third process, the maximum data size determination unit 320A determines whether or not the current maximum data size of the transmission packet has reached the maximum value limit_transsize.

When the current maximum data size has not reached the maximum value, the maximum data size determination unit 320A increases the maximum data size of the transmission packet by a predetermined size, and determines whether or not the transfer rate acquired by the transfer rate measuring circuit 310 has improved after the increase in the maximum data size.

When the transfer rate has improved, the maximum data size determination unit 320A further increases the maximum data size of the transmission packet with a condition that the current maximum data size has not reached the maximum value.

Then, the maximum data size determination unit 320A determines whether or not the transfer rate acquired by the transfer rate measuring circuit 310 has improved after the increase in the maximum data size, and when the transfer rate has not improved, the unit puts the data size back to the maximum data size before the change (for example, the previous data size).

### [Fourth Process in Sixth Determination Process]

As the fourth process, the maximum data size determination unit 320A performs the following process when stall has occurred.

The maximum data size determination unit 320A determines whether or not the current maximum data size of the transmission packet has reached the minimum value based on the relationship between the transfer rate information acquired by the transfer rate measuring circuit 310 and the minimum value min_transsize of the maximum data size.

When the current maximum data size has not reached the minimum value, the maximum data size determination unit 320A reduces the maximum data size of the transmission packet by a predetermined size.

The maximum data size determination unit 320A determines whether or not the transfer rate measured by the transfer rate measuring circuit 310 has improved after the reduction in the maximum data size.

When the transfer rate has improved, the maximum data size determination unit 320A determines whether or not stall has occurred. When stall has occurred, the maximum data size determination unit 320A further reduces the maximum data size of the transmission packet with a condition that the current maximum data size has not reached the minimum value.

Then, the maximum data size determination unit 320A determines whether or not the transfer rate acquired by the transfer rate measuring circuit 310 has improved after the reduction in the maximum data size.

When the transfer rate has not improved, the maximum data size determination unit 320A puts the data size back to the maximum data size before the change (for example, the previous data size).

When stall has not occurred, the maximum data size determination unit 320A determines that the reduction in the transfer rate by flow control is resolved, and finishes the process.

Furthermore, the fourth, the fifth, and the sixth determination process functions can be included individually, in plural or all together, or can be applied in appropriate combination.

Next, specific example of the fourth, the fifth, and the sixth determination processes will be described in relation to flowcharts.

### [Specific Setting Example of Maximum Data Size in Fourth Determination Process]

Next, a process of setting the maximum data size max_transsize in the fourth determination process of the maximum data size determination unit 320A according to the second embodiment will be described.

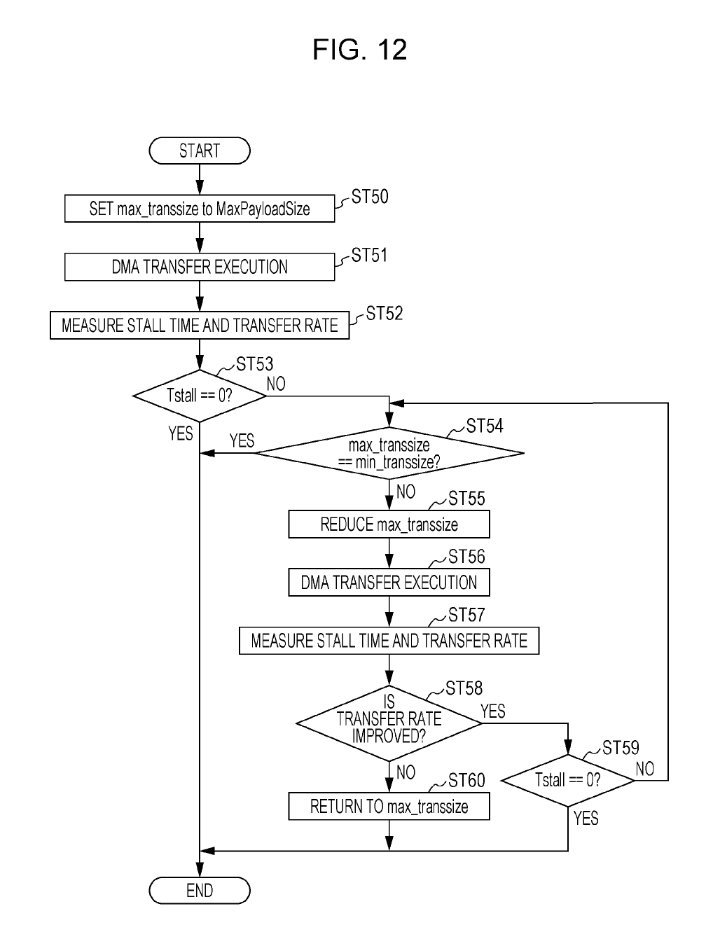

FIG. 12 is a flowchart for describing the process of setting the maximum data size max_transsize in the fourth determination process of the maximum data size determination unit according to the embodiment.

The maximum data size determination unit 320A sets the maximum payload size MaxPayloadSize defined as the initial value of the maximum data size max_transsize (ST50).

Under the control of the DMA controller 27 based on the set maximum data size, DMA transfer is executed through the serial transfer I/F 26 (ST51). In parallel with the process, the transfer rate at that moment is measured by the transfer rate measuring circuit 310, and a stall time (presence or non-presence of stall) is measured by the stall time measuring circuit 330 (ST52).

The maximum data size determination unit 320A determines whether or not stall has occurred based on the measurement result of the stall time measuring circuit 330 (ST53), and when stall has occurred, the unit performs the next process.

The maximum data size determination unit 320A determines whether or not the current maximum data size of the transmission packet has reached the minimum value based on the relationship between the transfer rate information acquired by the transfer rate measuring circuit 310 and the minimum value min_transsize of the maximum data size (ST54).

When the current maximum data size has not reached the minimum value, the maximum data size determination unit 320A reduces the maximum data size of the transmission packet by a predetermined size (ST55).

Under the control of the DMA controller 27 based on the reduced and set maximum data size, DMA transfer is executed through the serial transfer I/F 26 (ST56). In parallel with the process, the transfer rate at that moment is measured by the transfer rate measuring circuit 310 again, and a stall time (presence or non-presence of a stall time) is measured by the stall time measuring circuit 330 again (ST57).

Then, the maximum data size determination unit 320A determines whether or not the transfer rate acquired by the transfer rate measuring circuit 310 has improved after the reduction in the maximum data size (ST58).

When the transfer rate has improved, the maximum data size determination unit 320A determines whether or not stall has occurred (ST59).

When stall has occurred, the maximum data size determination unit 320A further reduces the maximum data size of the transmission packet with a condition that the current maximum data size has not reached the minimum value.

Then, the maximum data size determination unit 320A determines whether or not the transfer rate acquired by the transfer rate measuring circuit 310 has improved after the reduction in the maximum data size.

When the transfer rate has not improved, the maximum data size determination unit 320A puts the data size back to the maximum data size before the change (for example, the previous data size) (ST60).

When stall has not occurred in Step ST59, the maximum data size determination unit 320A determines that the reduction in the transfer rate by flow control is resolved, and finishes the process.

In addition, when stall has not occurred in Step ST59, the maximum data size determination unit 320A determines that there is no reduction in the transfer rate by flow control, and finishes the process.

### [Specific Setting Example of Maximum Data Size in Fifth Determination Process]

Next, a process of setting the maximum data size max_transsize in the fifth determination process of the maximum data size determination unit 320A according to the second embodiment will be described.

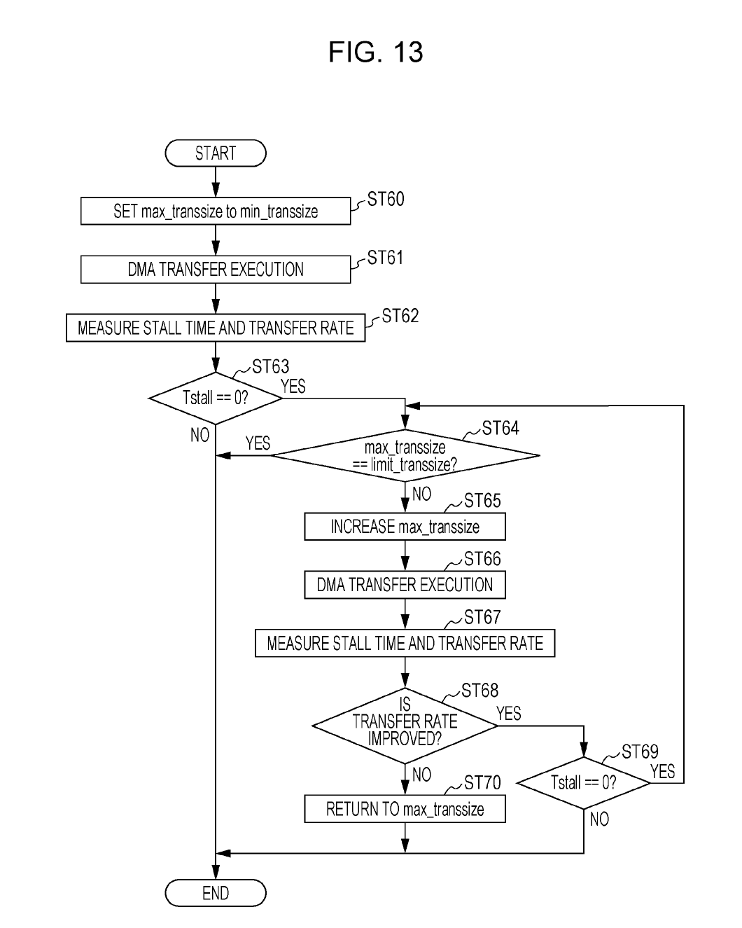

FIG. 13 is a flowchart for describing the process of setting the maximum data size max_transsize in the fifth determination process of the maximum data size determination unit according to the second embodiment.

The maximum data size determination unit 320A sets the minimum value min_transsize defined as the initial value of the maximum data size max_transsize (ST60).

Under the control of the DMA controller 27 based on the set maximum data size, DMA transfer is executed through the serial transfer I/F 26 (ST61). In parallel with the process, the transfer rate at that moment is measured by the transfer rate measuring circuit 310, and a stall time (presence or non-presence of a stall time) is measured by the stall time measuring circuit 330 (ST62).

The maximum data size determination unit 320A determines whether or not stall has occurred based on the measurement result of the stall time measuring circuit 330 (ST63), and when stall has not occurred, the unit performs the next process.

The maximum data size determination unit 320A determines whether or not the current maximum data size of the transmission packet has reached the maximum value based on the relationship between the transfer rate information acquired by the transfer rate measuring circuit 310 and the maximum value limit_transsize of the maximum data size (ST64).

When the current maximum data size has not reached the maximum value, the maximum data size determination unit 320A increases the maximum data size of the transmission packet by a predetermined size (ST65).

Under the control of the DMA controller 27 based on the increased and set maximum data size, DMA transfer is executed through the serial transfer I/F 26 (ST66). In parallel with the process, the transfer rate at that moment is measured by the transfer rate measuring circuit 310 again, and a stall time (presence or non-presence of a stall time) is measured by the stall time measuring circuit 330 again (ST67).

Then, the maximum data size determination unit 320A determines whether or not the transfer rate acquired by the transfer rate measuring circuit 310 has improved after the increase in the maximum data size (ST68).

When the transfer rate has improved, the maximum data size determination unit 320A determines whether or not stall has occurred (ST69).

When stall has not occurred, the maximum data size determination unit 320A further reduces the maximum data size of the transmission packet with a condition that the current maximum data size has not reached the maximum value.

Then, the maximum data size determination unit 320A determines whether or not the transfer rate acquired by the transfer rate measuring circuit 310 has improved after the reduction in the maximum data size.

When the transfer rate has not improved, the maximum data size determination unit 320A puts the data size back to the maximum data size before the change (for example, the previous data size) (ST70).

When stall has occurred in Step ST69, the maximum data size determination unit 320A determines that insufficiency occurs in credit, and finishes the process.

In addition, when stall has occurred in Step ST63, the maximum data size determination unit 320A determines that it is difficult to expect improvement in the transfer rate even after the increase in the maximum data size, and finishes the process.

### [Specific Setting Example of Maximum Data Size in Sixth Determination Process]

Next, a process of setting the maximum data size max_transsize in the sixth determination process of the maximum data size determination unit 320A according to the second embodiment will be described.

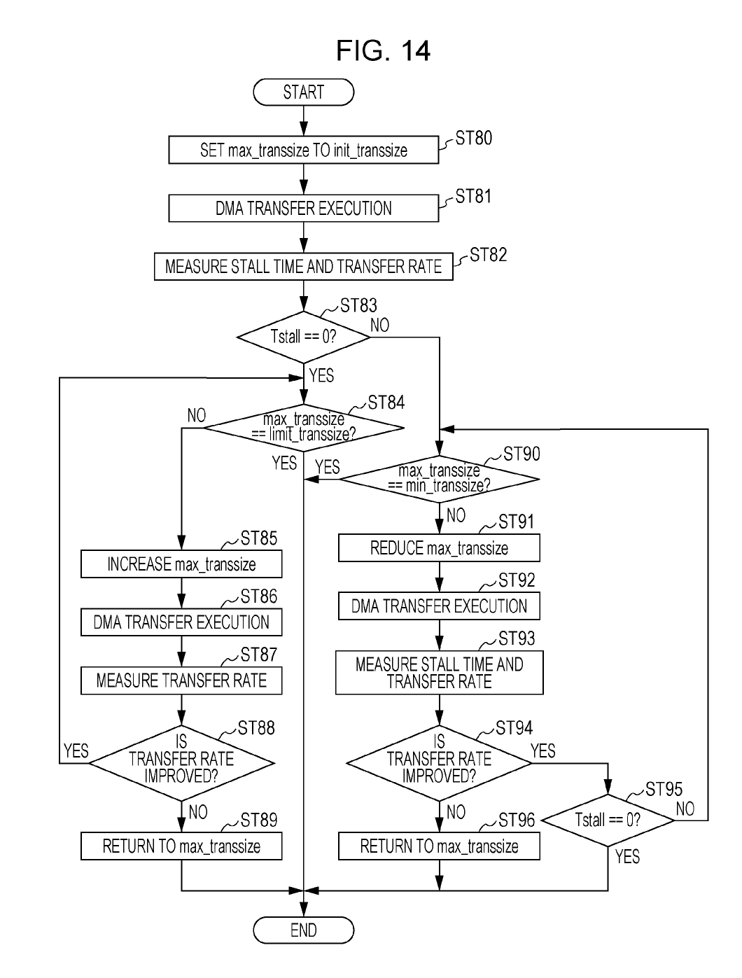

FIG. 14 is a flowchart for describing the process of setting the maximum data size max_transsize in the sixth determination process of the maximum data size determination unit according to the second embodiment.

The maximum data size determination unit 320A sets the maximum data size max_transsize to the initial value init_transsize set in advance (ST70).

Under the control of the DMA controller 27 based on the set maximum data size, DMA transfer is executed through the serial transfer I/F 26 (ST71). In parallel with the process, the transfer rate at that moment is measured by the transfer rate measuring circuit 310, and a stall time (presence or non-presence of a stall time) is measured by the stall time measuring circuit 330 (ST72).

The maximum data size determination unit 320A determines whether or not stall has occurred based on the measurement result of the stall time measuring circuit 330 (ST73), and when stall has not occurred, the unit performs the third process, and when stall has occurred, the unit performs the fourth process.

### [Specific Example of Third Process in Sixth Determination Process]

As the third process, the maximum data size determination unit 320A determines whether or not the current maximum data size of the transmission packet has reached the maximum value limit_transsize (ST84).

When the current maximum data size has not reached the maximum value, the maximum data size determination unit 320A increases the maximum data size of the transmission packet by a predetermined size (ST85).

Under the control of the DMA controller 27 based on the increased and set maximum data size, DMA transfer is executed through the serial transfer I/F 26 (ST86), and the transfer rate at that moment is measured by the transfer rate measuring circuit 310 again (ST87).

The, the maximum data size determination unit 320A determines whether or not the transfer rate acquired by the transfer rate measuring circuit 310 has improved further than the transfer rate previously measured after the increase in the maximum data size (ST88).

When the transfer rate has improved, the maximum data size determination unit 320A determines that the influence of overhead resulting from turning the data into packets is lessened, and the process returns to the process of Step S84, and the processes of Steps ST84 to ST88 are repeated until the current maximum data size reaches the maximum value.

Then, when the transfer rate has improved in Step ST88, the maximum data size determination unit 320A determines that a reduction in the transfer rate has occurred due to the lack of credit, and puts the data size back to the maximum data size before the change (for example, the previous data size) (ST89).

### [Specific Example of Fourth Process in Sixth Determination Process]

As the fourth process, the maximum data size determination unit 320A determines whether or not the current maximum data size of the transmission packet has reached the minimum value min_transsize (ST90).

When the current maximum data size has not reached the minimum value, the maximum data size determination unit 320A reduces the maximum data size of the transmission packet by a predetermined size (ST91).

Under the control of the DMA controller 27 based on the reduced and set maximum data size, DMA transfer is executed through the serial transfer I/F 26 (ST92). In parallel with the process, the transfer rate at that moment is measured by the transfer rate measuring circuit 310 again, and a stall time (presence or non-presence of a stall time) is measured by the stall time measuring circuit 330 again (ST93).

Then, the maximum data size determination unit 320A determines whether or not the transfer rate acquired by the transfer rate measuring circuit 310 has improved further than the transfer rate previously measured after the reduction in the maximum data size (ST94).

When the transfer rate has improved, the maximum data size determination unit 320A determines whether or not stall has occurred (ST95).

When stall has occurred, the maximum data size determination unit 320A further reduces the maximum data size of the transmission packet with a condition that the current maximum data size has not reached the minimum value.

Then, the maximum data size determination unit 320A determines whether or not the transfer rate acquired by the transfer rate measuring circuit 310 has improved after the reduction in the maximum data size.

When the transfer rate has not improved, the maximum data size determination unit 320A puts the data size back to the maximum data size before the change (for example, the previous data size) (ST96).

When stall has not occurred in Step ST95, the maximum data size determination unit 320A determines that the reduction in the transfer rate by flow control is resolved, and finishes the process.

When data transfer is performed using the serial transfer I/F such as PCI Express, the amount of reception buffer differs by equipment. In addition, latency until the transmission side receives the notification of release of a reception buffer also differs depending on the combination of equipment, and the data size of packets that realizes the maximum transfer rate changes.

According to the embodiments, it is possible to automatically calculate the optimal data size according to the combination of equipment and to maximize the transfer rate.

In other words, according to the embodiments, it is possible to determine the data size in data transfer by considering flow control not only by overhead resulting from turning the data into packets but also by credit, and to suppress a reduction in the transfer rate.

In addition, the method described above in detail can be formed as a program according to the procedure, and can configured to be executed in a computer such as a CPU.

In addition, it is possible to configure a program of that kind such that the program can be executed by being accessed by a recording medium including a semiconductor memory, a magnetic disk, an optical disc, a floppy (registered trademark) disk, or the like and by a computer amounted with the recording medium.

The present disclosure contains subject matter related to that disclosed in Japanese Priority Patent Application JP 2010-286123 filed in the Japan Patent Office on Dec. 22, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
a serial transfer interface which performs serial transfer for data in a unit of packets between counterparty devices;
a transfer control unit which performs control of data transfer of the serial transfer interface; and
a transfer state monitoring unit which monitors a data transfer state including a data size being subjected to data transfer of the serial transfer interface controlled by the transfer control unit according to a set maximum data size of a transmission packet, determines and can change the maximum data size of a transmission packet to be transmitted next according to the monitored state, and supplies the determined maximum data size to the transfer control unit,
wherein the transfer control unit performs control of data transfer of the serial transfer interface according to the maximum data size of the transmission packet supplied from the transfer state monitoring unit.

2. The information processing device according to claim 1, wherein the transfer state monitoring unit includes at least a transfer rate acquisition unit which acquires a transfer rate from data transfer state information including a data size being subjected to data transfer by the serial transfer interface, and a maximum data size determination unit which determines the maximum data size of a transmission packet to be transmitted based on the relationship between transfer rate information acquired by the transfer rate acquisition unit and the set maximum data size, and can change the maximum data size of the transmission packet.

3. The information processing device according to claim 2, wherein the maximum data size determination unit of the transfer state monitoring unit determines whether or not the transfer rate acquired by the transfer rate acquisition unit has improved after the maximum data size of the transmission packet is changed, further changes the maximum data size of the transmission packet and determines whether or not the transfer rate has improved when the transfer rate has improved, and puts the data size back to the maximum data size before the change when the transfer rate has not improved.

4. The information processing device according to claim 3,
wherein the set maximum data size of the transmission packet is defined with the minimum value that is the minimum value within a set range in advance, and
wherein the maximum data size determination unit sets a defined maximum payload size as the initial value of the maximum data size, and determines whether or not the current maximum data size of the transmission packet has reached the minimum value based on the relationship between transfer rate information acquired by the transfer rate acquisition unit and the minimum value of the maximum data size; reduces the maximum data size of the transmission packet by a predetermined size when the current maximum data size has not reached the minimum value, and determines whether or not the transfer rate acquired by the transfer rate acquisition unit has improved after the reduction in the maximum data size; further reduces the maximum data size of the transmission packet with a condition that the current maximum data size has not reached the minimum value when the transfer rate has improved, and determines whether or not the transfer rate acquired by the transfer rate acquisition unit has improved after the reduction in the maximum data size; and puts the data size back to the maximum data size before the change when the transfer rate has not improved.

5. The information processing device according to claim 3,
wherein the set maximum data size of the transmission packet is defined with the minimum value that is the minimum value and the maximum value that is the maximum value within a set range in advance, and
wherein the maximum data size determination unit sets the defined minimum value of the maximum data size as the initial value of the maximum data size, and determines whether or not the current maximum data size of the transmission packet has reached the maximum value based on the relationship between transfer rate information acquired by the transfer rate acquisition unit and the maximum value of the maximum data size; increases the maximum data size of the transmission packet by a predetermined size when the current maximum data size has not reached the maximum value, and determines whether or not the transfer rate acquired by the transfer rate acquisition unit has improved after the increase in the maximum data size; further increases the maximum data size of the transmission packet with a condition that the current maximum data size has not reached the maximum value when the transfer rate has improved, and determines whether or not the transfer rate acquired by the transfer rate acquisition unit has improved after the increase in the maximum data size; and puts the data size back to the maximum data size before the change when the transfer rate has not improved.

6. The information processing device according to claim 3,
wherein the set maximum data size of the transmission packet is defined with the minimum value that is the minimum value and the maximum value that is the maximum value within a set range in advance, and
wherein the maximum data size determination unit sets the maximum data size to the initial value set in advance, and determines whether or not the current maximum data size of the transmission packet has reached the maximum value based on the relationship between transfer rate information acquired by the transfer rate acquisition unit and the maximum value of the maximum data size; increases the maximum data size of the transmission packet by a predetermined size when the current maximum data size has not reached the maximum value, and determines whether or not the transfer rate acquired by the transfer rate acquisition unit has improved after the increase in the maximum data size; performs a first process when the transfer rate has improved; and puts the data size back to the maximum data size before the change to perform a second process when the current maximum data size has reached the maximum value or when the transfer rate has not improved; and as the first process, the unit determines whether or not the current maximum data size of the transmission packet has reached the maximum value; increases the maximum data size of the transmission packet by a predetermined size when the current maximum data size has not reached the maximum value and determines whether or not the transfer rate acquired by the transfer rate acquisition unit has improved after the increase in the maximum data size; further increases the maximum data size of the transmission packet with a condition that the current maximum data size has not reached the maximum value when the transfer rate has improved, and determines whether or not the transfer rate acquired by the transfer rate acquisition unit has improved after the increase in the maximum data size; and puts the data size back to the maximum data size before the change when the transfer rate has not improved; and as the second process, the unit determines whether or not the current maximum data size of the transmission packet has reached the minimum value; reduces the maximum data size of the transmission packet by a predetermined size when the current maximum data size has not reached the minimum value, and determines whether or not the transfer rate acquired by the transfer rate acquisition unit has improved after the reduction in the maximum data size; further reduces the maximum data size of the transmission packet with a condition that the current maximum data size has not reached the minimum value when the transfer rate has improved, and determines whether or not the transfer rate acquired by the transfer rate acquisition unit has improved after the reduction in the maximum data size; and puts the data size back to the maximum data size before the change when the transfer rate has not improved.

7. The information processing device according to claim 2,
wherein the transfer state monitoring unit further includes a stall measurement unit which measures occurrence of stall in data transmission during data transfer execution of the serial transfer interface, and
wherein the maximum data size determination unit can determine the maximum data size of the transmission packet to be transmitted based on the measurement result of the stall measurement unit and the relationship between transfer rate information acquired by the transfer rate acquisition unit and the set maximum data size, and change the maximum data size of the transmission packet.

8. The information processing device according to claim 7,
wherein the set maximum data size of the transmission packet is defined with the minimum value that is the minimum value within a set range in advance, and
wherein the maximum data size determination unit sets a defined maximum payload size as the initial value of the maximum data size; determines whether or not stall has occurred based on the measurement result of the stall measurement unit; determines whether or not the current maximum data size of the transmission packet has reached the minimum value based on the relationship between transfer rate information acquired by the transfer rate acquisition unit and the minimum value of the maximum data size when stall has occurred; reduces the maximum data size of the transmission packet by a predetermined size when the current maximum data size has not reached the minimum value, and determines whether or not the transfer rate acquired by the transfer rate acquisition unit has improved after the reduction in the maximum data size; determines whether or not stall has occurred when the transfer rate has improved; further reduces the maximum data size of the transmission packet with a condition that the current maximum data size has not reached the minimum value when stall has occurred, and determines whether or not the transfer rate acquired by the transfer rate acquisition unit has improved; and puts the data size back to the maximum data size before the change when the transfer rate has not improved.

9. The information processing device according to claim 7,
wherein the set maximum data size of the transmission packet is defined with the minimum value that is the minimum value and the maximum value that is the maximum value within a set range in advance, and
wherein the maximum data size determination unit sets the defined minimum value of the maximum data size as the initial value of the maximum data size; determines whether or not stall has occurred based on the measurement result of the stall measurement unit; determines whether or not the current maximum data size of the transmission packet has reached the maximum value based on the relationship between transfer rate information acquired by the transfer rate acquisition unit and the maximum value of the maximum data size when stall has not occurred; increases the maximum data size of the transmission packet by a predetermined size when the current maximum data size has not reached the maximum value, and determines whether or not the transfer rate acquired by the transfer rate acquisition unit has improved; determines whether or not stall has occurred when the transfer rate has improved; further increases the maximum data size of the transmission packet with a condition that the current maximum data size has not reached the maximum value when stall has not occurred, and determines whether or not the transfer rate acquired by the transfer rate acquisition unit has improved after the increase in the maximum data size; and puts the data size back to the maximum data size before the change when the transfer rate has not improved.

10. The information processing device according to claim 7,
wherein the set maximum data size of the transmission packet is defined with the minimum value that is the minimum value and the maximum value that is the maximum value within a set range in advance, and
wherein the maximum data size determination unit sets the maximum data size to the initial value set in advance; determines whether or not stall has occurred based on the measurement result of the stall measurement unit; performs a third process when stall has not occurred, and performs a fourth process when stall has occurred; as the third process, the unit determines whether or not the current maximum data size of the transmission packet has reached the maximum value; increases the maximum data size of the transmission packet by a predetermined size when the current maximum data size has not reached the maximum value and determines whether or not the transfer rate acquired by the transfer rate acquisition unit has improved after the increase in the maximum data size; further increases the maximum data size of the transmission packet with a condition that the current maximum data size has not reached the maximum value when the transfer rate has improved, and determines whether or not the transfer rate acquired by the transfer rate acquisition unit has improved after the increase in the maximum data size; and puts the data size back to the maximum data size before the change when the transfer rate has not improved; and as the fourth process, the unit determines whether or not the current maximum data size of the transmission packet has reached the minimum value based on the relationship between the transfer rate information acquired by the transfer rate acquisition unit and the minimum value of the maximum data size; reduces the maximum data size of the transmission packet by a predetermined size when the current maximum data size has not reached the minimum value, and determines whether or not the transfer rate acquired by the transfer rate acquisition unit has improved after the reduction in the maximum data size; determines whether or not stall has occurred when the transfer rate has improved; further reduces the maximum data size of the transmission packet with a condition that the current maximum data size has not reached the minimum value when stall has occurred, and determines whether or not the transfer rate acquired by the transfer rate acquisition unit has improved after the reduction in the maximum data size; and puts the data size back to the maximum data size before the change when the transfer rate has not improved.

11. The information processing device according to claim 1, comprising:
a transfer residual data size acquisition unit which acquires remaining data size of transferred data; and
an address boundary data size acquisition unit which acquires a data size to the address boundary,
wherein the serial transfer interface is prohibited from generating a packet which makes access spanning predetermined address boundaries, and
wherein, the transfer control unit sets a smaller one between a first data size obtained by the transfer residual data size acquisition unit or a second data size obtained by the address boundary data size acquisition unit as the data size of the transmission packet when the first data size or the second data size is smaller than the set maximum data size; and sets the maximum data size supplied by the transfer state monitoring unit as the data size of the transmission packet when the first data size or the second data size is smaller than the set maximum data size.

12. An information processing system comprising:
a transmission side device which transmits data by serial transfer; and
a reception side device which receives data transmitted from the transmission side device, stores the received data in a reception buffer, and performs notification of release of the reception buffer to the transmission side device,
wherein the transmission side device includes a serial transfer interface which performs serial transfer for data in a unit of packets between the reception side device, a transfer control unit which performs control of data transfer of the serial transfer interface, and a transfer state monitoring unit which monitors a data transfer state including a data size being subjected to data transfer of the serial transfer interface controlled by the transfer control unit according to a set maximum data size of a transmission packet, determines and can change the maximum data size of a transmission packet to be transmitted next according to the monitored state, and supplies the determined maximum data size to the transfer control unit, and
wherein the transfer control unit performs control of data transfer of the serial transfer interface according to the maximum data size of the transmission packet supplied by the transfer state monitoring unit.

13. An information processing method, comprising:
performing serial transfer for data in a unit of packets by a serial transfer interface between counterparty devices;
performing control of data transfer of the serial transfer interface; and
performing monitoring of a data transfer state in which a data transfer state including a data size being subjected to data transfer of the serial transfer interface controlled in the control of the data transfer according to a set maximum data size of a transmission packet is monitored, the maximum data size of a transmission packet to be transmitted next is determined and can be changed according to the monitored state, and the determined maximum data size is supplied to the control of the data transfer,
wherein control of data transfer of the serial transfer interface is performed in the control of the data transfer according to the maximum data size of the transmission packet supplied from the monitoring of the data transfer state.

14. A program which causes a computer to execute information processing, comprising:
performing serial transfer for data in a unit of packets by a serial transfer interface between counterparty devices;
performing control of data transfer of the serial transfer interface; and
performing monitoring of a data transfer state in which a data transfer state including a data size being subjected to data transfer of the serial transfer interface controlled in the control of the data transfer according to a set maximum data size of a transmission packet is monitored, the maximum data size of a transmission packet to be transmitted next is determined and can be changed according to the monitored state, and the determined maximum data size is supplied to the control of the data transfer,
wherein control of data transfer of the serial transfer interface is performed in the control of the data transfer according to the maximum data size of the transmission packet supplied from the monitoring of the data transfer state.
